(19) United States
(12) Patent Application Publication
(10) Pub. No.: US 2026/0351095 A1
(43) Pub. Date: Nov. 5, 2026

(54) SELF-CHECKOUT LAYOUT OPTIMIZATION

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 19/194,375

(22) Filed: Apr. 30, 2025

(51) Int. Cl. G07G 1/00; G06Q 10/0639; G06Q 30/02

(52) U.S. Cl. CPC G07G 1/0036; G06Q 10/0639; G06Q 30/02

(57) ABSTRACT

Methods and systems for optimizing self-checkout store layouts using artificial intelligence are provided. A method analyzes store traffic and characteristics to optimize self-checkout layout configurations, considering multiple format attributes including price variations, labor requirements, hardware specifications, physical space constraints, security measures, and payment method support. A two-level processing model employs machine learning model to analyze big data from self-checkout lanes and an optimization algorithm to determine optimal layout configurations. The methods and systems balance costs and occupancy while adhering to space limitations and retailer preferences, resulting in improved efficiency and reduced operational costs.

### BACKGROUND

Self-checkout platforms are increasingly prevalent in retail stores worldwide, enhancing shopper experience, reducing queues, and lowering labor costs. However, optimizing the layout of self-checkout devices presents significant challenges without automated solutions. Retailers currently rely on intuition and trial-and-error methods for determining self-checkout layouts, leading to inefficiencies and increased costs. Self-checkout layout optimization can be influenced by a number of factors such as the number of lanes, the area occupied, transaction traffic support, labor costs, security levels, downtime, maintenance costs, transaction length, customer satisfaction, and overall device subscription costs.

### BRIEF DESCRIPTION OF THE DRAWINGS

FIG. 1 is a diagram of a system for self-checkout (SCO) layout optimization, according to an example embodiment.

FIG. 2 is a flow diagram of a method for SCO layout optimization, according to an example embodiment.

FIG. 3 is a flow diagram of another method for SCO layout optimization, according to an example embodiment.

### DETAILED DESCRIPTION

The retail industry continues to embrace self-checkout (SCO) technology as a fundamental component of modern store operations. The configuration and placement of SCO systems within retail environments directly impacts operational efficiency, customer experience, and bottom-line results. Current layout decisions face multiple challenges related to varying format costs, labor allocation, hardware requirements, space utilization, and security implementation.

Key considerations in SCO deployment include managing different lane formats with distinct price points, determining appropriate staffing levels for intervention response, selecting optimal hardware configurations, and efficiently utilizing available floor space. Additional factors encompass security measure implementation, payment method flexibility, and the ability to convert lanes between self-service and assisted modes during peak periods.

Hardware specifications for SCO lanes significantly impact layout decisions, including the types of processors, scales, scanners, and printers utilized in each lane format. These hardware configurations affect customer satisfaction, system availability, downtime frequency, and ongoing maintenance costs. Additional hardware considerations include specific security and computer vision utilities for vision-based SCO, which impact shrink levels and overall security effectiveness.

The absence of data-driven methodologies for layout optimization results in retailers relying on subjective decision-making processes that often lead to suboptimal configurations, increased operational costs, and reduced customer satisfaction. These intuition-based and trial-and-error approaches prevent retailers from achieving optimal SCO implementations, resulting in millions of dollars in inefficiencies across their store networks.

The manual configuration process results in substantial financial impact across retail operations. Traditional trial-and-error approaches to SCO layout optimization has led to millions of dollars in inefficiencies through suboptimal lane utilization, excessive labor costs, and unnecessary hardware investments. These costs compound across store networks, creating significant operational expenses that could be avoided through automated optimization techniques.

The technical challenge lies in developing an automated system capable of processing complex multi-variable data related to SCO operations and determining optimal layout configurations while accounting for physical constraints, operational requirements, and retailer preferences. The current technological limitations prevent retailers from effectively analyzing and processing the numerous data points needed to optimize SCO implementations, including lane formats, costs, space utilization, and security measures, resulting in inefficient manual configuration processes.

The technology presented herein improves computer-implemented retail management systems by introducing a specialized two-level processing model that processes store-specific data through a machine learning model (MLM) and an optimization algorithm, enabling automated generation of store-specific layout configurations that maximize efficiency while minimizing costs. This technological advancement transforms the traditional manual layout decision process into an automated, data-driven system that continuously learns from operational data to provide increasingly optimized configurations, while considering multiple format attributes including physical dimensions, cost structures, adoption rates, payment capabilities, and security features.

In an embodiment presented herein, a two-level processing model processes store-specific data to determine optimal self-checkout configurations. The first level employs a MLM to analyze operational data from self-checkout lanes, establishing relationships between layout measures and performance outcomes.

In various embodiments, the second level utilizes an optimization algorithm that leverages the first level MLM's output to identify ideal layout configurations based on store-specific parameters and retailer preferences. This automated process considers multiple format attributes including physical dimensions, cost structures, adoption rates, payment capabilities, and security features.

In an embodiment presented herein, the MLM may be implemented as a random forest machine learning model that analyzes the relationships between self-checkout layout parameters and performance metrics. The random forest model processes multiple decision trees in parallel to evaluate various layout configurations and their impact on operational efficiency, enabling robust prediction capabilities across diverse store environments.

In another embodiment, a supervised MLM may be employed to analyze the relationships between layout parameters and performance outcomes. The supervised learning approach enables the system to learn from historical data of successful layout implementations, continuously improving its predictive accuracy as more operational data becomes available.

In an embodiment presented herein, the MLM receives various data inputs related to different SCO lane formats, including physical size specifications and basket size support capabilities, cost data encompassing purchase and maintenance expenses, shopper adoption rate metrics, tender type support information indicating card, cash, or dual payment capabilities, security and computer vision capabilities data, and information regarding lane conversion capabilities to assisted mode.

In various embodiments, the MLM processes input data regarding the general available space for SCO lanes in the store, along with store traffic characteristics and other store-specific operational parameters. The MLM analyzes these inputs to establish relationships between layout measures and performance outcomes, which forms the foundation for optimizing layout configurations.

In an embodiment, the MLM outputs learned relationships between measures and outcomes which builds the layout's trade-off calculations, including total cost considerations and occupancy performance metrics. These output relationships enable the optimization algorithm to determine desired trade-off values for generating optimal layout configurations.

In another embodiment, the MLM processes granulated measures of SCO layout historical operational data to automatically learn all relations between measures and outcomes. The MLM transforms these granulated data points into parameters, weights, and frameworks that can be utilized by the optimization algorithm to find the best SCO lanes layout for each specific store.

In various embodiments presented herein, the optimization algorithm may utilize either linear or non-linear optimization techniques to generate optimal layout configurations. The optimization algorithm processes the output from the MLM to determine the most efficient arrangement of SCO lanes while considering multiple constraints such as physical space limitations, cost parameters, and retailer-specified requirements. The algorithm evaluates various combinations of lane formats and quantities to identify configurations that minimize total costs while maintaining desired occupancy levels and operational efficiency.

In an embodiment presented herein, the optimization algorithm utilizes the MLM's output to find the best SCO lanes layout for the store based on all measures and restrictions, automatically generating store-specific configurations. The algorithm processes the learned relationships between layout measures and performance outcomes to optimize both total cost and adequate occupancy levels.

In various embodiments, the optimization algorithm considers retailer-specific configurations which allow each retailer to tune different optimization goals using simple business terms. These business terms are automatically translated to the measures used by the machine learning and optimization algorithms to generate appropriate layout configurations.

In an embodiment, the optimization algorithm provides multi-solution capabilities to the retailer, enabling experimentation with different trade-offs without requiring trial-and-error implementations. The algorithm immediately shows the impact of each optional change on the SCO lanes efficiency bottom line, saving retailers from costly physical reconfigurations.

In another embodiment, the optimization algorithm processes multiple format attributes including physical size and basket size support, cost of purchase and maintenance, adoption rate metrics, tender type support, security capabilities, and conversion abilities to determine the optimal configuration of SCO lanes in the store. The algorithm optimizes these configurations such that overall cost, including lane and labor expenses, will be minimal while maintaining adequate occupancy levels.

In various embodiments presented herein, the SCO layout optimization system integrates with the a vision-based SCO platform. The system may be consumed by any SCO platform that integrates with the existing service layers enabling broad compatibility across different retail environments while leveraging existing infrastructure investments.

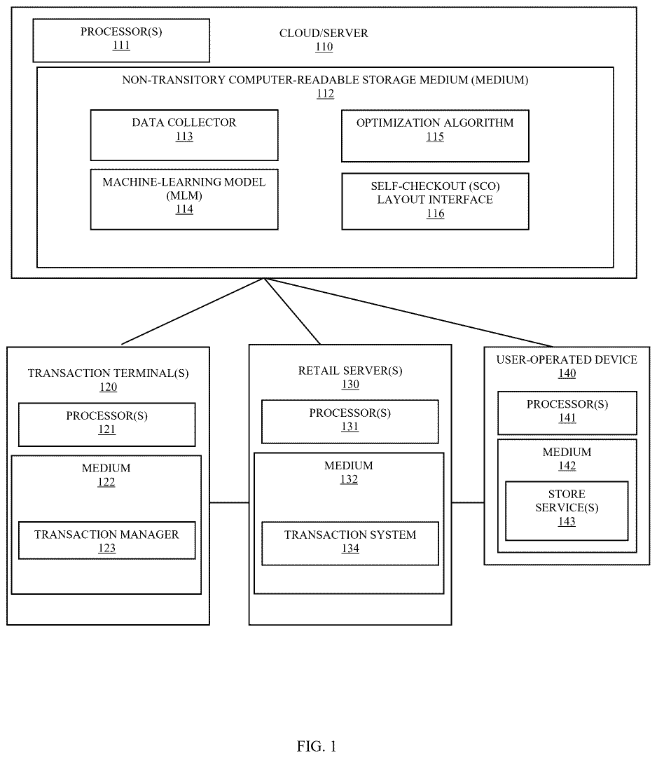

FIG. 1 is a diagram of a system 100 for SCO layout optimization, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of SCO layout optimization presented herein and below.

System 100 includes a cloud 110 or a server (hereinafter just “cloud 110” may also be referred to herein as “cloud server”), transaction terminals 120, one or more retail servers 130, and user-operated devices 140. Cloud 110 includes a processor 111 and a non-transitory computer-readable storage medium (medium) 112, which includes executable instructions for data collector 113, a MLM 114, an optimization algorithm 115, and a SCO layout interface 116. Processor 111 executes the instructions causing processor 111 to perform operations discussed herein and below with respect to 113-116.

Each transaction terminal 120 includes a processor 121 and a non-transitory computer-readable storage medium 122, which includes instructions for a transaction manager 123. Processor 121 executes the instructions causing processor 121 to perform operations discussed herein and below with respect to transaction manager 123.

Each retailer server 130 includes a processor 131 and a non-transitory computer-readable storage medium 132, which includes executable instructions for a transaction system 134. Processor 131 executes the instructions causing processor 131 to perform operations discussed herein and below with respect to transaction system 134.

Each user-operated device 140 includes a processor 141 and a non-transitory computer-readable storage medium 142, which includes instructions for one or more store service 143. Processor 141 executes the instructions causing processor 141 to perform operations discussed herein and below with respect to store service 143.

In an embodiment presented herein, data collector 113 receives transaction data from transaction manager 123 executing on transaction terminal 120 and transaction system 134 executing on retail server 130. The data collector 113 aggregates historical transaction data, store traffic patterns, and operational metrics from multiple SCO lanes to establish a comprehensive dataset for analysis.

In various embodiments, data collector 113 processes multiple data types including physical space constraints, hardware specifications, security system configurations, payment method capabilities, and lane conversion parameters. The collected data provides granular insights into SCO lane performance, customer interaction patterns, and operational efficiency metrics that form the foundation for layout optimization.

In an embodiment presented herein, MLM 114 processes the collected data to establish relationships between layout parameters and performance outcomes. The MLM 114 implements either random forest or supervised learning techniques to analyze transaction patterns, space utilization, staffing requirements, and security measures across different SCO lane formats.

In various embodiments, MLM 114 continuously updates its analytical models based on new transaction data and performance metrics received from data collector 113. This dynamic learning process enables MLM 114 to refine its understanding of layout efficiency factors and their impact on store operations.

In an embodiment presented herein, optimization algorithm 115 processes the output from MLM 114 to generate optimal SCO layout configurations. The algorithm 115 employs either linear or non-linear optimization techniques to evaluate multiple format combinations while adhering to physical space constraints and retailer-specified requirements.

In various embodiments, optimization algorithm 115 processes retailer-specific parameters received through SCO layout interface 116 to customize layout configurations. The algorithm 115 translates business requirements into technical parameters that guide the optimization process while maintaining specified operational thresholds.

In an embodiment presented herein, SCO layout interface 116 communicates with store service 143 on user-operated device 140 to deliver optimized layout configurations. The interface 116 provides visualization capabilities that enable retailers to evaluate multiple layout scenarios and their projected impact on operational efficiency.

In various embodiments, SCO layout interface 116 receives retailer preferences and constraints through store service 143, enabling real-time adjustment of optimization parameters. The interface 116 facilitates interactive refinement of layout configurations while maintaining integration with the external platforms and service layers.

In an embodiment presented herein, transaction manager 123 and transaction system 134 provide real-time transaction data to data collector 113, enabling continuous performance monitoring of implemented layouts. This feedback loop allows MLM 114 and optimization algorithm 115 to validate and refine their models based on actual operational outcomes.

In various embodiments, store service 143 provides a user interface for retailers to interact with the optimization system, enabling configuration of business rules, visualization of layout options, and monitoring of performance metrics. The service 143 translates complex optimization outputs into actionable implementation guidance while maintaining integration with existing store systems.

In an embodiment presented herein, data collector 113 implements a multi-threaded data processing pipeline that simultaneously aggregates and normalizes transaction data streams from multiple SCO lanes. The collector 113 processes raw transaction logs to extract key performance indicators including transaction duration, intervention frequency, payment method utilization, and hardware status metrics, while maintaining temporal relationships between correlated events.

In various embodiments, data collector 113 employs specialized data transformation algorithms to process heterogeneous data types from different SCO formats. The collector 113 implements format-specific parsers that process data from different hardware configurations, including scale weight sensor streams, scanner read patterns, payment terminal interaction logs, and security system alerts, converting these diverse inputs into standardized data structures for MLM analysis.

In an embodiment presented herein, data collector 113 utilizes a distributed processing architecture to handle real-time data ingestion from transaction manager 123 and transaction system 134. The collector 113 implements data validation protocols that verify data integrity, handle missing values, and normalize measurement scales across different SCO formats, while maintaining synchronization between transaction events and corresponding hardware performance metrics.

In various embodiments, data collector 113 implements adaptive sampling algorithms that adjust data collection frequency based on transaction volume and system load. The collector 113 processes security and computer vision data streams from vision-based SCO systems or platforms, correlating security events with transaction patterns and hardware performance metrics to establish comprehensive operational profiles for each SCO format.

In an embodiment presented herein, MLM 114 processes hardware configuration data including processor specifications, scale calibration parameters, scanner read rates, and printer performance metrics to evaluate the technical capabilities and limitations of each SCO lane format. The MLM 114 analyzes how these hardware specifications correlate with transaction processing times, system availability rates, and maintenance requirements to establish hardware-specific performance relationships.

In an embodiment presented herein, MLM 114 implements a random forest model architecture that processes multiple decision trees in parallel to evaluate layout configurations. The MLM 114 constructs decision trees using specific feature vectors including transaction volume patterns, hardware performance metrics, space utilization parameters, and security coverage indicators, enabling robust prediction capabilities across diverse store environments.

In various embodiments, MLM 114 employs supervised learning techniques that utilize labeled historical data to train the model's predictive capabilities. The MLM 114 processes training datasets containing successful layout implementations, correlating input parameters such as physical dimensions, hardware specifications, and traffic patterns with validated performance outcomes including transaction throughput, intervention rates, and customer satisfaction metrics.

In an embodiment presented herein, MLM 114 implements an adaptive training pipeline that continuously refines model parameters based on operational feedback. The MLM 114 processes performance data from implemented layouts to update its prediction weights, automatically adjusting feature importance scores and decision boundaries to improve accuracy across different store configurations and hardware combinations.

In various embodiments, MLM 114 utilizes specialized data transformation layers that convert raw input data into normalized feature vectors. The MLM 114 implements format-specific preprocessing algorithms that standardize diverse inputs including processor configurations, scale specifications, scanner coverage patterns, and security system parameters, enabling consistent model training across different hardware platforms and store environments.

In an embodiment presented herein, MLM 114 employs a hierarchical learning architecture that processes layout parameters at multiple granularity levels. The MLM 114 analyzes relationships between hardware specifications and performance metrics at both individual lane and store-wide levels, enabling comprehensive understanding of how specific equipment configurations impact overall layout efficiency.

In various embodiments, optimization algorithm 115 incorporates hardware-specific constraints when generating layout configurations, including processing power requirements, scale placement parameters, scanner coverage zones, and printer accessibility factors. The algorithm 115 evaluates how different combinations of hardware configurations impact overall system performance, considering factors such as processor load balancing, scale interference patterns, scanner coverage optimization, and printer queue management.

In an embodiment presented herein, optimization algorithm 115 implements a multi-stage transformation pipeline that converts business-level parameters into quantifiable technical metrics. The algorithm 115 first decomposes retailer-specified business terms into constituent operational factors, such as converting “peak hour coverage” into specific temporal transaction volume thresholds, staffing level requirements, and lane conversion timing parameters.

In various embodiments, optimization algorithm 115 employs a parametric mapping framework that transforms business requirements into weighted technical constraints. For example, the algorithm converts retailer-specified “shopper experience preferences” into measurable parameters including maximum wait time thresholds, optimal transaction processing speeds, and lane availability ratios, while “security requirements” are transformed into specific computer vision coverage zones, scale sensitivity thresholds, and intervention trigger parameters.

In an embodiment presented herein, optimization algorithm 115 utilizes a dynamic weighting system to balance multiple transformed technical parameters. The algorithm processes retailer-configured business goals through mathematical transformation matrices that convert qualitative preferences into quantitative optimization constraints, enabling precise technical trade-off calculations between factors such as attendant-to-lane ratios, hardware utilization thresholds, and space efficiency metrics.

In an embodiment presented herein, SCO layout interface 116 implements a dynamic visualization engine that generates interactive three-dimensional representations of optimized store layouts. The interface 116 processes spatial data and hardware specifications to render precise scale models of different SCO lane formats, including detailed representations of scanner zones, scale placement areas, and customer interaction spaces.

In various embodiments, SCO layout interface 116 employs real-time rendering algorithms to visualize operational metrics overlaid on layout configurations. The interface 116 generates heat maps showing customer traffic patterns, displays dynamic indicators for intervention zones based on configured attendant-to-lane ratios, and highlights security coverage areas based on computer vision system parameters.

In an embodiment presented herein, SCO layout interface 116 implements an interactive simulation framework that enables retailers to visualize the impact of layout modifications in real-time. The interface 116 processes optimization algorithm outputs to demonstrate how changes in lane quantity, format selection, and placement affect key performance metrics including customer wait times, throughput rates, and staffing requirements.

In various embodiments, SCO layout interface 116 utilizes a parametric visualization system that dynamically adjusts layout representations based on hardware-specific constraints. The interface 116 processes technical parameters including processor configurations, scale specifications, scanner coverage patterns, and security system requirements to generate accurate visual representations of operational zones and interaction spaces for each SCO format.

In an embodiment presented herein, transaction manager 123 implements a real-time event processing pipeline that captures and analyzes transaction events at the hardware level. The manager 123 processes granular interaction data including scanner read events, scale weight measurements, payment terminal interactions, and security system alerts, while maintaining temporal synchronization across multiple data streams.

In various embodiments, transaction manager 123 employs adaptive sampling algorithms that automatically adjust data collection frequency based on transaction volume and system load. The manager 123 implements hardware-specific data validation protocols that verify sensor readings, monitor system health metrics, and track intervention triggers across different SCO formats.

In an embodiment presented herein, transaction system 134 utilizes a distributed processing architecture to aggregate and normalize data streams from multiple transaction managers. The system 134 implements specialized data transformation algorithms that convert format-specific transaction logs into standardized data structures, while preserving hardware performance metrics and operational parameters for each SCO format.

In various embodiments, transaction system 134 processes real-time performance metrics to generate dynamic feedback signals for the optimization system. The system 134 implements continuous monitoring algorithms that track key performance indicators including transaction duration, intervention frequency, hardware utilization rates, and security event correlations, enabling real-time validation of layout optimization outcomes.

In an embodiment presented herein, the system 100 implements a spatial validation engine that processes three-dimensional representations of SCO lane formats against available floor space parameters. The validation engine applies hardware-specific placement constraints including minimum clearance zones for scanner coverage, scale interference prevention distances, and customer interaction spaces to verify physical feasibility of proposed layouts.

In various embodiments, the system 100 employs a hardware compatibility verification framework that evaluates technical requirements across different SCO formats. The framework processes specific hardware parameters including processor load distributions, power supply requirements, network connectivity zones, and maintenance access spaces to validate that proposed layouts maintain operational efficiency while meeting installation requirements.

In an embodiment presented herein, the system 100 utilizes a dynamic constraint checking algorithm that validates layouts against multiple format-specific criteria. The algorithm processes physical parameters including trolley lane dimensions, scan-and-go space requirements, and convertible lane configurations, while simultaneously verifying security system coverage zones and computer vision system placement for vision-based SCO systems or platforms.

In various embodiments, the system 100 implements real-time verification protocols that validate proposed layouts against historical transaction patterns. The verification engine processes operational data including peak hour traffic flows, intervention response paths, and payment method distributions to ensure optimized layouts maintain required service levels across different transaction scenarios.

In an embodiment presented herein, the system 100 employs an iterative validation process that continuously monitors implemented layouts against predicted performance metrics. The validation engine processes real-time transaction data to verify that actual space utilization, hardware performance, and operational efficiency align with optimization model predictions, enabling dynamic refinement of layout parameters based on empirical results.

In an embodiment presented herein, the system 100 implements specialized integration protocols that enable data exchange between transaction manager 123 and existing point-of-sale infrastructure. The transaction manager 123 processes hardware-level communications through standardized interfaces that capture transaction events, payment processing signals, and security alerts while maintaining compatibility with existing store systems.

In various embodiments, transaction system 134 employs a distributed architecture that interfaces with multiple retail server configurations. The system 134 implements format-specific data transformation layers that standardize transaction data from different point-of-sale (POS) platforms, enabling consistent processing of operational metrics while preserving integration with existing BSL implementations.

In an embodiment presented herein, data collector 113 utilizes adaptive integration frameworks that process data streams from diverse store systems. The collector 113 implements specialized parsers for different transaction platforms, hardware configurations, and security systems, enabling comprehensive data aggregation while maintaining existing system operations.

In various embodiments, store service 143 implements a modular integration architecture that enables seamless communication with existing store management systems. The service 143 processes layout configurations through standardized interfaces that maintain compatibility with external platform components while enabling integration with diverse retail environments.

In an embodiment presented herein, the system 100 employs real-time synchronization protocols that maintain data consistency across integrated platforms. The system 100 processes transaction events, hardware status updates, and security alerts through coordinated communication channels that preserve operational continuity while enabling optimization of layout configurations across different store infrastructures.

In various embodiments, each SCO lane format includes specific hardware components such as processors, scales, scanners, and printers configured according to the lane's intended use. The hardware configurations vary based on factors including transaction volume expectations, basket size support requirements, and security monitoring needs. Additional components may include security and computer vision systems for enhanced shrink prevention.

In an embodiment, terminals 120 include SCO terminals and/or POS terminals. In an embodiment, a SCO terminal is convertible to function as a POS terminal and convertible from a POS terminal to function as a SCO terminal. Each SCO lane includes its SCO terminal, a basket unloading area, a bagging area, scales, scanners, printers, card readers, etc.

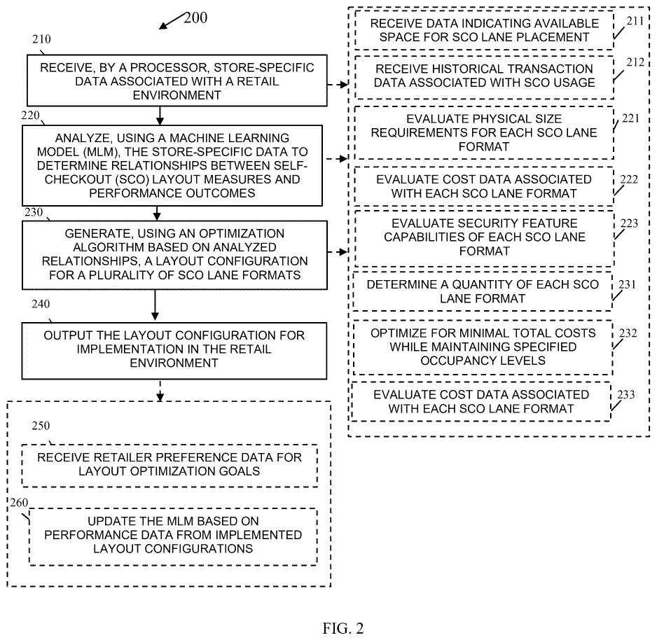

FIG. 2 illustrates a flow diagram of a method 200 for SCO layout optimization, according to an example embodiment. The software module(s) that implements the method 200 is referred to as a “SCO layout optimizer.” The SCO layout optimizer is implemented as executable instructions programmed and residing within memory and/or a non-transitory computer-readable (processor-readable) storage medium and executed by one or more processors of one or more devices. The processor(s) of the device(s) that executes the SCO layout optimizer are specifically configured and programmed to process the SCO layout optimizer. The SCO layout optimizer has access to one or more network connections during its processing. The connections can be wired, wireless, or a combination of wired and wireless.

In an embodiment, the device that executes SCO layout optimizer is cloud 110. In an embodiment, the device that executes SCO layout optimizer is retail server 130. In an embodiment, the SCO layout optimizer is all of, or some combination of 113-116. In an embodiment, the SCO layout optimizer is provided to a retail server 130 and/or a user-operated device 140 as a software-as-a-service (SaaS).

At 210, the SCO layout optimizer receives store-specific data associated with a retail environment of a store. In an embodiment, at 211, the SCO layout optimizer receives data indicating available space for SCO lane placement. In an embodiment, at 212, the SCO layout optimizer receives historical transaction data associated with SCO usage.

At 220, the SCO layout optimizer analyzes, using MLM 114, the store-specific data to determine relationships between SCO layout measures and performance outcomes. In an embodiment, at 221, the MLM 114 evaluates physical size requirements for each SCO lane format. In an embodiment, at 222, the MLM 114 evaluates cost data associated with each SCO lane format. In an embodiment, at 223, the SCO layout optimizer evaluates security feature capabilities of each SCO lane format.

At 230, the SCO layout optimizer, using an optimization algorithm 115 that implements a pipeline to convert business level parameters into quantifiable metrics and determines a layout configuration for a plurality of SCO lane formats based on the determined relationships of 220. In an embodiment, at 231, the optimization algorithm 115 determines a quantity of each SCO lane format.

At 240, the SCO layout optimizer outputs the layout confirmation for implementation in the retail environment of the store. In an embodiment, at 250, the SCO layout optimizer receives retailer preference data for layout optimization goals. In an embodiment, at 260, the SCO layout optimizer updates the MLM 114 based on performance data from implemented layout configurations within the retail environment of the store.

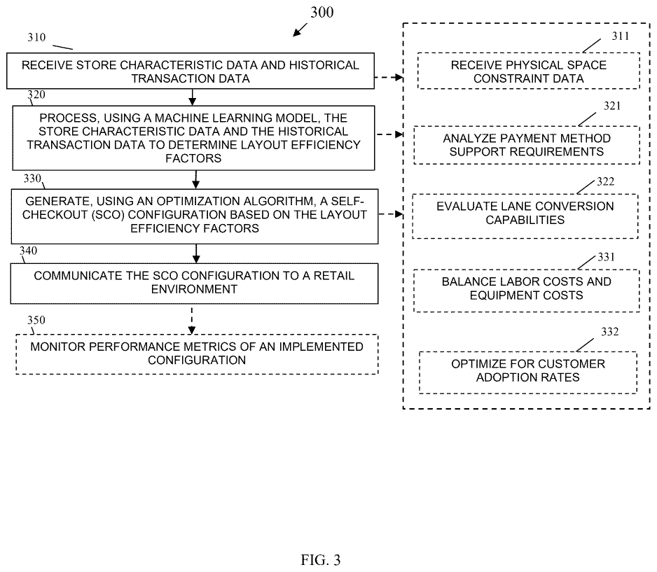

FIG. 3 illustrates a flow diagram of another method 300 for SCO layout optimization, according to an example embodiment. The software module(s) that implements the method 300 is referred to as a “SCO layout optimization recommender.” The SCO layout optimization recommender is implemented as executable instructions programmed and residing within memory and/or a non-transitory computer-readable (processor-readable) storage medium and executed by one or more processors of one or more devices. The processor(s) of the device(s) that executes the SCO layout optimization recommender are specifically configured and programmed to process the SCO layout optimization recommender. The SCO layout optimization recommender has access to one or more network connections during its processing. The network connections can be wired, wireless, or a combination of wired and wireless.

In an embodiment, the device that executes the SCO layout optimization recommender is cloud 110. In an embodiment, the device that executes the SCO layout optimization recommender is retail server 130. In an embodiment, the SCO layout optimization recommender is provided to a retail server 130 and/or a user-operated device 140 as a SaaS.

In an embodiment, the SCO layout optimization recommender is all of, or some combination of 113-116, and/or method 200. The SCO layout optimization recommender presents another and, in some ways, enhanced processing perspective from that which was discussed above with the method 200 of the FIG. 2.

At 310, the SCO layout optimization recommender receives store characteristic data and historical transaction data. In an embodiment, at 311, the SCO layout optimization recommender receives physical constraint data.

At 320, the SCO layout optimization recommender processes, using MLM 114, the store characteristic data and the historical transaction data to determine layout efficiency factors. In an embodiment, at 321, the MLM 114 analyzes payment method support requirements. In an embodiment, at 322, the SCO layout optimization recommender evaluates lane conversion capabilities.

At 330, the SCO layout optimization recommender generates, using optimization algorithm 115 that incorporates hardware-specific constraints including one or more of processing power requirements, scale placement parameters, scanner coverage zones, and/or printer accessibility factors, a SCO configuration based on the layout efficiency factors of 320. In an embodiment, at 331, the optimization algorithm 115 balances labor costs and equipment costs. In an embodiment, at 332, the optimization algorithm optimizes for customer adoption rates.

At 340, the SCO layout optimization recommender communicates the SCO configuration to a retail environment such as a store service 143 or a store system. In an embodiment, at 350, the SCO layout optimization recommender monitors performance metrics of an implemented configuration.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a processor, store-specific data associated with a retail environment;
analyzing, using a machine learning model (MLM), the store-specific data to determine relationships between self-checkout (SCO) layout measures and performance outcomes;
generating, using an optimization algorithm based that implements a pipeline to convert business level parameters into quantifiable metrics and that determines a layout configuration for a plurality of SCO lane formats based on the determined relationships; and
outputting the layout configuration for implementation in the retail environment.

2. The method of claim 1, wherein receiving store-specific data comprises receiving data indicating available space for SCO lane placement.

3. The method of claim 1, wherein receiving store-specific data comprises receiving historical transaction data associated with SCO usage.

4. The method of claim 1, wherein analyzing the store-specific data comprises evaluating physical size requirements for each SCO lane format.

5. The method of claim 1, wherein analyzing the store-specific data comprises evaluating cost data associated with each SCO lane format.

6. The method of claim 1, wherein analyzing the store-specific data comprises evaluating security feature capabilities of each SCO lane format.

7. The method of claim 1, wherein generating the layout configuration comprises determining a quantity of each SCO lane format.

8. The method of claim 1, wherein generating the layout configuration comprises optimizing for minimal total cost while maintaining specified occupancy levels.

9. The method of claim 1, wherein generating the layout configuration comprises adhering to a specified attendant-to-lane ratio.

10. The method of claim 1, further comprising receiving retailer preference data for layout optimization goals.

11. The method of claim 1, further comprising updating the MLM based on performance data from implemented layout configurations.

12. A method, comprising:
receiving store characteristic data and historical transaction data;
processing, using a machine learning model (MLM), the store characteristic data and the historical transaction data to determine layout efficiency factors;
generating, using an optimization algorithm that incorporates hardware-specific constraints including one or more of processing power requirements, scale placement parameters, scanner coverage zones, or printer accessibility factors, a self-checkout (SCO) configuration based on the layout efficiency factors; and
communicating the SCO configuration to a retail environment.

13. The method of claim 12, wherein receiving store characteristic data comprises receiving physical space constraint data.

14. The method of claim 12, wherein processing the store characteristic data comprises analyzing payment method support requirements.

15. The method of claim 12, wherein processing the store characteristic data comprises evaluating lane conversion capabilities.

16. The method of claim 12, wherein generating the SCO configuration comprises balancing labor costs and equipment costs.

17. The method of claim 12, wherein generating the SCO configuration comprises optimizing for customer adoption rates.

18. The method of claim 12, further comprising monitoring performance metrics of an implemented configuration.

19. A system, comprising:
a data collection module configured to receive store-specific operational data;
a machine learning module (MLM) configured to analyze relationships between SCO layout parameters and performance metrics;
an optimization algorithm configured to implement a parametric mapping framework that transforms business requirements into weighted technical constraints and generates layout configurations based on analyzed relationships, wherein the optimization algorithm converts retailer-specified requirements into measurable parameters including maximum wait time thresholds, optimal transaction processing speeds, and lane availability ratios to generate SCO layout configurations; and
a SCO layout interface configured to provide implementation instructions for generated SCO layout configurations.

20. The system of claim 19, further comprising a monitoring agent configured to collect performance data from implemented layout configurations.
